(19) United States
(12) Patent Application Publication
(10) Pub. No.: US 2006/0009287 A1
(43) Pub. Date: Jan. 12, 2006

(54) Remote control using collectible object

(75) Inventor: Arnoud Engelfriet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/524,072

(22) PCT Filed: Jul. 18, 2003
(86) PCT No.: PCT/IB03/03276

§ 371 Date: Feb. 9, 2005

(30) Foreign Application Priority Data
Aug. 14, 2002 (EP) 02078367

(51) Int. Cl. A63F 13/00; A63F 13/08

(52) U.S. Cl. 463/35

(57) ABSTRACT

A method of allowing remote control of an apparatus (130) using a collectible object (110). The collectible object (110) comprises an audio playback device (111, 112, 115), said device (111, 112, 115) being arranged to play back a sound (120) in which a command is embedded. This object (110) is provided to owners of the apparatus (130), e.g. through promotional activities. The apparatus (130) is adapted to receive the sound (120) with the embedded command, to extract the command from the sound (120) and to execute the command. By distributing collectible objects like trading cards and/or Flippo's with small audio playback apparatus, the trading cards can control the toys.

The invention relates to collectible objects such as trading cards, that are typically used in conjunction with games, and to a method of allowing remote control of an apparatus such as a game console, electronic toy or computer-controlled gaming system.

International patent application WO 02/39739 (attorney docket PHNL000591) discloses a system in which controllable devices such as electronic toys are provided with embedded watermark detectors. Commands intended for the toys are embedded using watermarks in a television or radio program which is subsequently broadcast or otherwise transmitted. If the owner of the controllable device brings his device within reception range of the signal, the watermark detector can pick up the embedded command and subsequently the device executes it. For example, a toy can be arranged to move its arm or other limb, but also to play a song or output some sentence or word in response to receiving the appropriate command. The commands can be embedded at locations in a television program where the corresponding actions occur in the television program.

This arrangement provides a business opportunity for toy manufacturers, who can now create exciting new toys that can “play along” with television programs and the like. Further, the toys can be used as effective advertising medium, by repeating the message from a commercial TV or encouraging the purchasing of objects presented in an advertisement by responding positively, e.g. by shouting excitedly or pointing at the television. If the advertisement is confirmed by this toy, the owner is more likely to respond to it positively.

A disadvantage of this business opportunity is that it requires the co-operation of the television or radio content providers. After all, the signals in which the commands for the toys are embedded are their television or radio programs, and so they must be convinced to embed these commands in their content. It is to be expected that they will charge a fee. This reduces the potential income for the toy manufacturers. Thus, there is a need for a business opportunity that allows toy manufacturers to effectively market watermark-controlled toys, without depending on third parties for distributing the commands to the toys.

According to the present invention there is provided a collectible object such as a trading card comprising an audio playback device, said device being arranged to play back a sound in which a command is embedded. Preferably the command is embedded using a watermark. When a user activates the apparatus in the proximity of the watermark-controlled toy (or other device), the toy will detect the command and execute it. This invention can be applied in a variety of situations.

Because the signal in which the watermark is embedded now no longer represents a television program or the like, it is not necessary for the toy manufacturer to share his profits with anyone else. He can simply manufacture the toys and the collectible objects himself (or outsource this of course) and can so completely control the market. By selectively adjusting the quantities in which particular objects are produced, an artificial scarcity can be created which increases demand.

Preferably the sound comprises an audible representation of the embedded command. This way it is clear to the owner/operator of the collectible object which command is being given. The audio playback device may be arranged to play back the sound only a limited number of times. This forces the owner of the collectible object to periodically purchase anew object.

The invention also provides a method of allowing remote control of an apparatus, comprising providing a collectible object comprising an audio playback device, said device being arranged to play back a sound in which a command is embedded, wherein the apparatus is adapted to receive the sound with the embedded command, to extract the command from the sound and to execute the command. As a confirmation, the apparatus may repeat the sound upon the reception of the sound.

The command can be executed by reducing an artificial limitation on a performance parameter of the apparatus. This way the performance of the apparatus can be influenced using the collectible object, making them more desirable.

The command may identify a game element represented by the collectible object. The apparatus then executes the command by introducing the game element into a game being controlled by the apparatus. This way the collectible objects provide a real-life extension to computerized games. Game elements obtained by collecting objects can now be introduced in the electronic game.

Preferably the collectible object is provided during a promotional activity related to the apparatus.

These and other aspects of the invention will be apparent from and elucidated with reference to the embodiments shown in the Figures, in which

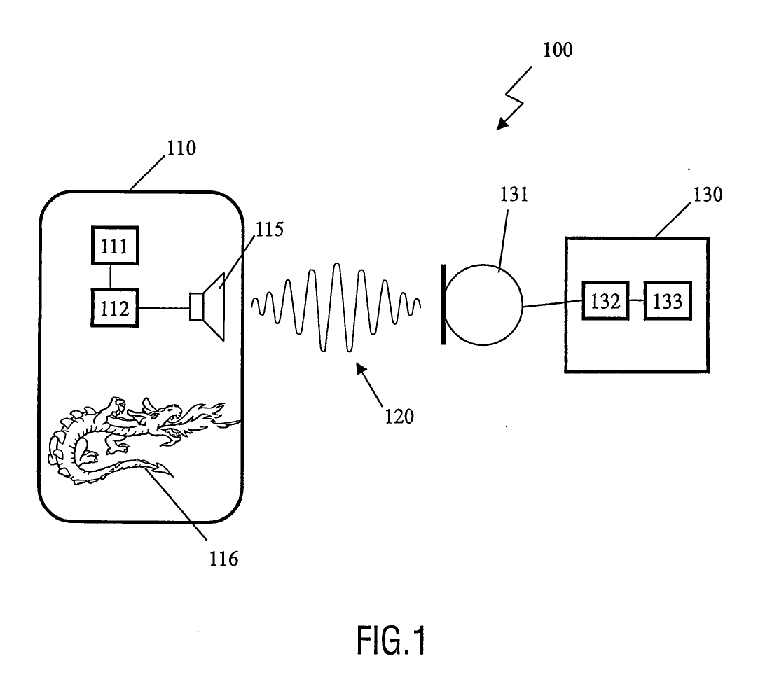

FIG. 1 schematically shows a first embodiment of the invention, comprising a collectible object and a controllable device;

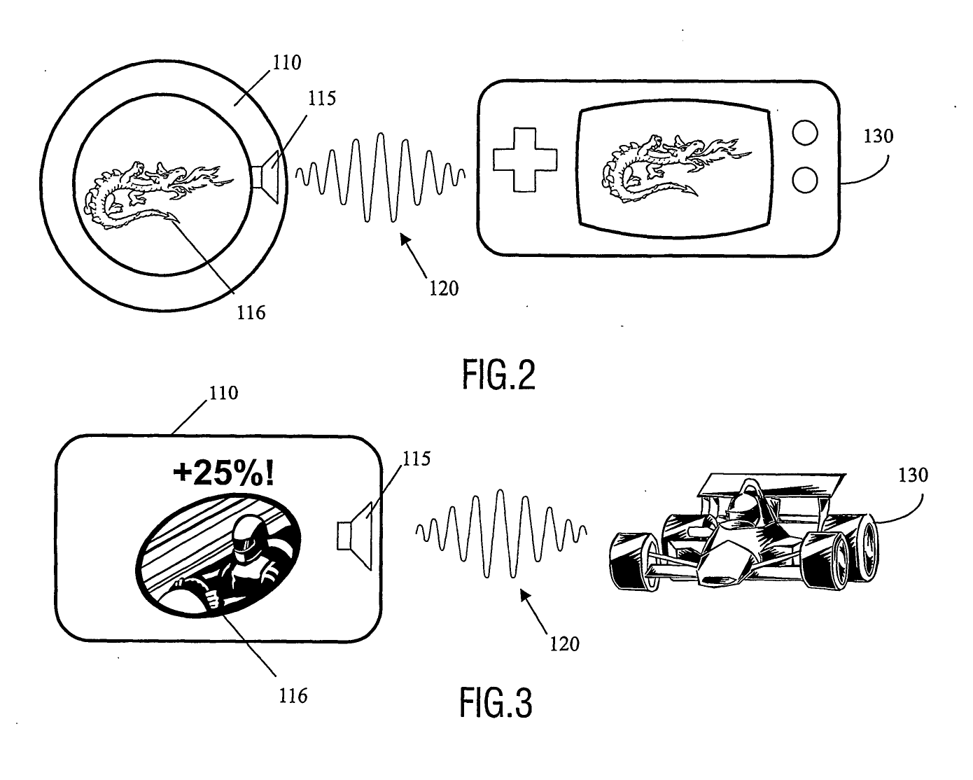

FIG. 2 illustrates another embodiment in which the invention is used to enhance an electronic game; and

FIG. 3 illustrates yet another embodiment in which the invention is used to influence the performance of a toy.

Throughout the figures, same reference numerals indicate similar or corresponding features. Some of the features indicated in the drawings are typically implemented in software, and as such represent software entities, such as software modules or objects.

FIG. 1 schematically shows an arrangement 100 comprising a collectible object 110 and a controllable device 130. The collectible object 110 comprises activation module 111, audio playback module 112 and audio output module 115. The object 110 is decorated with a game element 116, here a graphical representation of a dragon.

When the user operates the activation module 111, for example embodied as a button, switch or touch-sensitive surface, the audio playback module 112 is triggered to produce a sound in which a command is embedded, preferably by means of a watermark. Alternatively the command could be embedded using inaudible tones or using predetermined types of audio to construct the sound. The sound is then rendered audibly as signal 120 using the output module 115, here shown as a loudspeaker.

In its most simple form, the collectible object 110 can only produce a single sound with a single embedded command. This makes the object 110 the cheapest and easiest to construct, and requires that a user collects a large number of different collectible objects to have a large number of embedded commands at his disposal. By itself such simple sound chips are known from e.g. musical postcards.

The quality of the sound produced by such a chip may be low, and it may not even be possible to embed a command using watermarks without audible distortions. However, this is not a problem, especially in the context of games. No high quality is expected, and the distortions may even create a mysterious effect for the listener. One could even use “white noise” or static as the sound in which the command is embedded.

One could of course also construct collectible objects that are able to produce different sounds (with mutually different embedded commands) or to embed different command in one sound upon different activations.

The controllable device 130 comprises receiving module 131, detecting module 132 and executing module 133. The receiving module 131 receives the signal 120, decodes and processes it and feeds it to the detecting module 132. The receiving module 131 can be for instance a microphone or audio-sensitive sensor of some kind.

The detecting module 132 obtains the embedded command from the signal 120, preferably by detecting the watermark and extracting the command from the watermark. Detecting a watermark and extracting embedded information is well known in the art and will not be elaborated upon further.

The command is then fed to the executing module 133 which executes the command. The command may relate to control of a physical movement of a part of the controllable device 130, rendering of an audio output by the controllable device 130, rendering of a visual output by the controllable device 130, adjusting a value for at least one parameter associated with the command, or other actions which the controllable device 130 should perform.

The commands can be embedded as short identifiers representing commands, for example numbers that are assigned to specific commands beforehand. This makes the information that needs to be embedded very short, and it still allows potentially long and complex commands to be embedded. The controllable device 130 then merely needs to look up the corresponding command for the identifier that is embedded in the signal 120. A single command may trigger a sequence of predetermined actions. For example, the single command “start to dance” may trigger movements of the legs, head and arms of a doll that is suitably equipped.

For details on the construction of devices that can be remotely controlled using commands embedded using watermark technology in audio signals, the reader is referred to, amongst others, the above-mentioned international patent application WO 02/39739, and to international patent applications WO 01/61987 and WO 01/33836.

The collectible object 110 is shown in FIG. 1 as a trading card, but it can of course be any type of collectible object. Examples are coins, miniature figures or statues or so-called “Flippo's” or caps. It is of course long known that such objects can be traded or collected. More recently some of these collectible objects have become useful in the context of gaming. For example, U.S. Pat. No. 5,662,332 discloses a method of playing a game using trading cards, commonly known under the trademark “Magic: The Gathering”.

In such games, different cards represent different objects to be used in the game, or different properties or “powers” for particular objects. For example, a player may have a card representing a warrior. Bringing this card into play then is interpreted as attacking the other player with that warrior. The other player could respond by bringing a card representing a dragon into play, for instance. In addition to cards, physical objects like miniature statues of the warrior and/or the dragon could be used in the game. A card could then represent an attack by the dragon with a particular severity.

In accordance with the present invention, these trading cards are provided with the above mentioned modules 111, 112, 115. Bringing the card into play is then done by activating the module 111, which causes the card to produce a sound. For example, if the card represents a particular attack to be performed by the warrior, the sound could be an audible command like “Attack from the flanks!” or a battle cry. The miniature statue of the warrior could respond appropriately by repeating the battle cry, or, if the statue is a robot, move the arms of the warrior so as to simulate an attack. It's clear that such an enhancement makes the game much more attractive.

FIG. 2 illustrates another embodiment in which the invention is used to enhance an electronic game played on a game console like the Nintendo Gameboy. See a.o. U.S. Pat. No. 5,095,798, U.S. Pat. No. 5,552,799, or USD 371,353 for details on this game console. The game console 130 could be a hand-held gaming console, an arcade game machine or a computer program running on a general purpose or specially adapted computer.

Many electronic games have so-called “cheat functions”. Using these function a player could for example easily get extra weapons or other objects for use in the game, earn extra points, walk through walls, get access to a map of the entire gaming environment, and so on. Typically the code necessary to activate a cheat function is supplied by pressing a specific sequence on a keyboard and/or operating a joystick in a particular way. In accordance with the invention, this code can be supplied using the collectible object 110.

Flippo's (small, round trading objects) originally represented characters from the Gameboy console game “Pokémon” (see U.S. Pat. No. 6,251,010 or U.S. Pat. No. 6,251,012), and were distributed amongst players of this game so that they could trade them with each other and play games using the Flippo's as game tokens. It was not possible to use e.g. a Flippo representing a valuable Pokémon character in the electronic Pokémon game, or vice versa.

In accordance with the present invention, a Flippo 110 can be activated in the presence of the game console 130. This causes the character in the game corresponding to the character represented by the Flippo to e.g. perform an attack. In the Pokémon game, every character has a distinct battle cry, usually the same as its name. So, preferably activating the Flippo causes it to audibly render this battle cry. Clearly, this has the advantage that the player gets immediate audible and visible feedback from the Flippo and the console game about his action.

In another embodiment, shown in FIG. 3, a toy 130 such as a racing car or toy robot can be controlled by activating the appropriate collectible object 110. For instance a racing car could be provided with an artificial limitation on its maximum speed, causing it to normally operate at 80 percent of its theoretical maximal speed. The operator can then buy “power packs”, collectible objects with embedded playback device. Upon activating such a power pack, control software in the racing car removes or reduces the artificial limitation so that the car (temporarily) runs faster. This gives the operator an advantage in car racing games. Of course, if one operator is allowed to use such power packs, other operators will want to do so as well and so will also buy the power packs. Clearly this is a very profitable business opportunity.

It should be noted that the above-mentioned embodiments illustrate rather than limit the invention, and that those skilled in the art will be able to design many alternative embodiments without departing from the scope of the appended claims. For example, the sound with embedded command may additionally comprise an embedded identifier for a particular controllable device 130 or a particular range of such devices. A controllable device that picks up the sound then only executes the command if the embedded identifier corresponds to its own identifier.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A collectible object comprising an audio playback device, said device being arranged to play back a sound in which a command is embedded.

2. The collectible object of claim 1, in which the command is embedded using a watermark.

3. The collectible object of claim 1, in which the sound comprises an audible representation of the embedded command.

4. The collectible object of claim 1, in which the device is arranged to playback the sound only a limited number of times.

5. A method of allowing remote control of an apparatus, comprising providing a collectible object comprising an audio playback device, said device being arranged to play back a sound in which a command is embedded, wherein the apparatus is adapted to receive the sound with the embedded command, to extract the command from the sound and to execute the command.

6. The method of claim 5, in which the command is executed by reducing an artificial limitation on a performance parameter of the apparatus.

7. The method of claim 5, in which the command identifies a game element represented by the collectible object and the apparatus executes the command by introducing the game element into a game being controlled by the apparatus.

8. The method of claim 5, in which the collectible object is provided during a promotional activity related to the apparatus.

9. The method of claim 5, in which the apparatus repeats the sound upon the reception of the sound.
